(19) United States
(12) Patent Application Publication
(10) Pub. No.: US 2026/0286820 A1
(43) Pub. Date: Sep. 24, 2026

(54) CLOSED LOOP FRACTURING UTILIZING OFFSET WELL DAS MONITORING

(71) Applicant: Halliburton Energy Services, Inc., Houston, TX (US)

(72) Inventors: Benjamin Schaeffer, Houston, TX (US); Casey Lee Cox, Houston, TX (US); Derek Shelby Bale, Houston, TX (US); John-Bosco Le Tran, Denver, CO (US); Awais Navaiz, Denver, CO (US)

(73) Assignee: Halliburton Energy Services, Inc., Houston, TX (US)

(21) Appl. No.: 19/336,184

(22) Filed: Sep. 22, 2025

Related U.S. Application Data
(60) Provisional application No. 63/775,855, filed on Mar. 21, 2025.

(51) Int. Cl. E21B 43/26; G05B 13/02

(52) U.S. Cl. CPC E21B 43/2607; G05B 13/0265; E21B 2200/20; E21B 2200/22

(57) ABSTRACT

acquiring sensor data at monitoring wells in proximity to fracturing wells and extracting answer products from the acquired sensor data utilizing a first trained optimization model. A second optimization model is trained utilizing the extracted answer products as engineered features and targets of optimized fracture parameters. The second optimization mode is deploying to generate real-time predictions based on the engineered features. System pumping parameter changes may then be implemented based on the real-time predictions of the second optimization model. In examples, the first and second optimization models may be machine learning models.

### CROSS REFERENCE TO RELATED APPLICATIONS

This application claims the priority of U.S. Provisional Patent Application No. 63/775,855, filed Mar. 21, 2025, which is incorporated by reference in its entirety.

### BACKGROUND

Hydrocarbons, such as oil and gas, are commonly obtained from subterranean formations that may be located onshore or offshore. The development of subterranean operations and the processes involved in removing hydrocarbons from a subterranean formation are complex. Subterranean operations involve a number of different steps such as, for example, drilling a wellbore at a desired well site, treating and stimulating the wellbore to optimize production of hydrocarbons, and performing the necessary steps to produce and process the hydrocarbons from the subterranean formation.

Generally, hydraulic fracturing operations use surface sensors to measure feedback and equipment performance. Data has also been collected from different forms of subsurface measurements. The data from subsurface measurements are used to make decisions on parameters of hydraulic fracturing operations.

### BRIEF DESCRIPTION OF THE DRAWINGS

These drawings illustrate certain aspects of some examples of the present disclosure and should not be used to limit or define the disclosure.

FIG. 1A is a diagram illustrating a fracturing operation.

FIG. 1B is a diagram illustrating an example system for treatment operations, according to aspects of the present disclosure.

FIG. 2 is a diagram illustrating an example pumping system, according to aspects of the present disclosure.

FIG. 3 illustrates a schematic of an information handling system.

FIG. 4 illustrates a schematic of a chip set.

FIG. 5 illustrates a computing network.

FIG. 6 illustrates a neural network.

FIG. 7 is a graph showing strain data measurements.

FIG. 8 is a workflow of raw data acquisition to recommender system implementation of frac spread optimizations.

FIG. 9 illustrates zones defined within a subterranean formation for fracture operations.

FIG. 10 is a workflow for completion development path.

FIGS. 11-12 are workflows for individual zones from FIG. 9.

### DETAILED DESCRIPTION

The present disclosure generally relates to systems and methods for automated hydraulic fracturing. Discussed below are methods and systems that may be used for the control and optimization of the hydraulic fracturing process utilizing near and far field data driven modelling and inference techniques in a real time sense. Traditionally this has been a difficult area in that answer product real time models must first be trained using some form of continuously measured diagnostic (fiber optics, pressure, etc.) to detect fracturing events in spatiotemporal or strictly temporal sense, which then must be used to train a model, such as a machine learning model, to determine their influence on an optimized fracturing attribute (geometry extents with respect to volume pumped, etc.). As used herein, the term “answer product” refers generally to an inference or interpretation, using a model and based on observed responses, such as from dynamic strain data in a fiber optic system, to a set of measured operational conditions and parameters during a fracturing process.

By acquiring DAS data within offset horizontal wells from the well(s) undergoing hydraulic fracturing processes and generating the answer products of micro seismic and low frequency spatiotemporal events via trained machine learning models, engineered features from these events can be extracted. Another set of events useful for the decision-making algorithm to be deployed would be the temporal data, without the spatial descriptor. A large population of answer product events engineered features are recorded for a variety of unconventional wells across global basins, which allows for the usage of machine learning modelling. These engineered features are utilized in a supervised learning sense to train a machine learning model (classification or regression sense) in which the target metric is about some key optimization (time delay between signals of interest on multiple fiber deployments normalized by spatial information and volume pumped, optimal frac geometry, etc.). Once the machine learning model has been trained, it will be used in real time to determine whether the target optimal metric of interest has been reached and if so, actions will be undertaken with respect to the current fracturing operations.

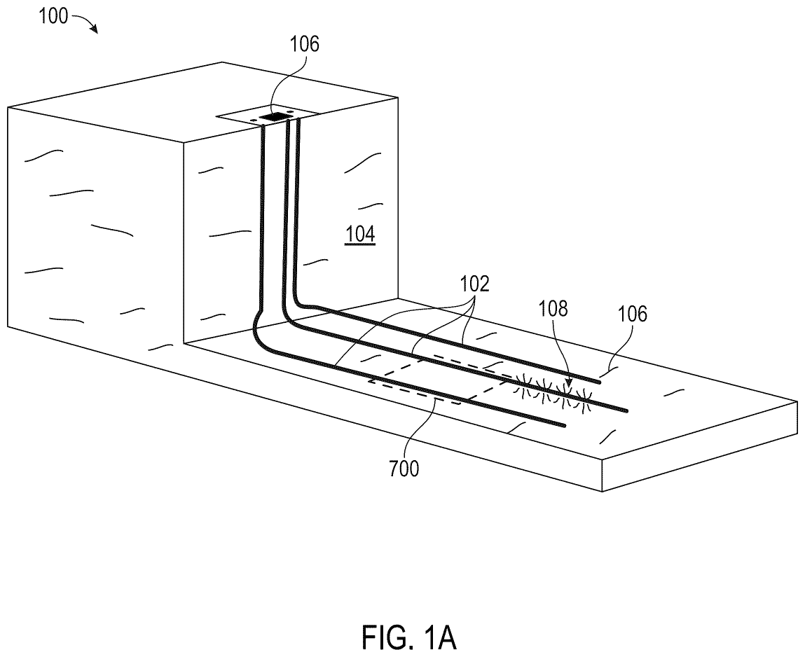

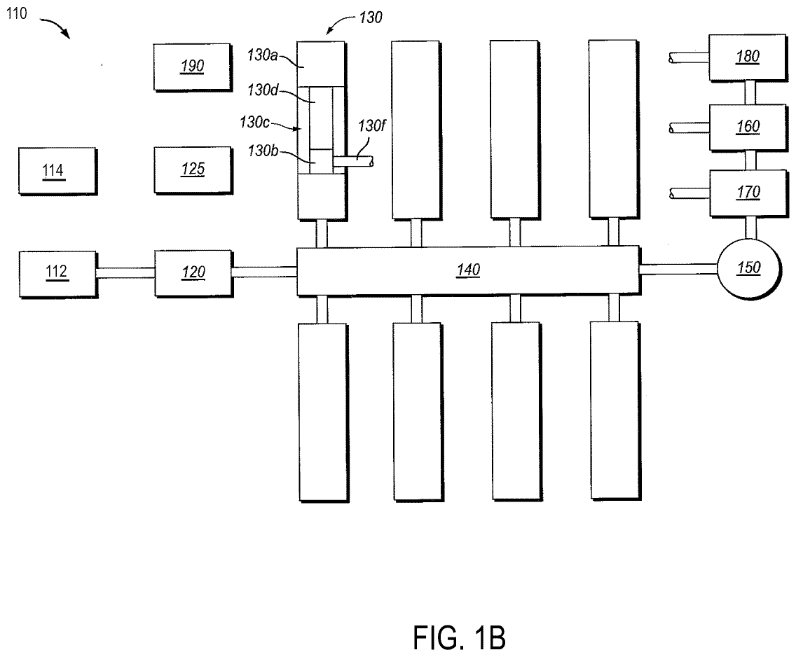

FIG. 1A is a diagram of an example fracturing environment. Fracturing operation 100 may include one or more wellbores 102 that may be formed within underground formation 104. Each wellbore 102 is a hole in formation 104 which may be formed by a drill string (and one or more components thereof) to access subterranean resource deposits. Boreholes 102 may be partially or fully lined with casing. Further, a wellhead 106 may be installed between the surface and borehole 102 to provide control and separation of the contents of borehole 102.

Casing is concrete and/or metal lining that separates a borehole 102 from the surrounding subterranean formation 104. Casing may be used to protect subterranean formation 104 from the contents that may traverse through a borehole 102, and conversely, to protect a borehole 102 from subterranean formation 104. In fracturing operation 100, casing may be constructed to withstand pressures greater than casings installed in a drilling environment.

A wellhead is a machine which may include one or more pipes, caps, and/or valves to provide pressure control for contents within boreholes 102. In any embodiment, wellhead 106 may be equipped with a blowout preventer to prevent the flow of higher-pressure fluids (in boreholes 102) from escaping to the surface in an uncontrolled manner. Wellhead 106 may be equipped with other ports and/or sensors to monitor pressures within boreholes 102 and/or otherwise facilitate drilling and/or fracturing operations.

Perforation holes are small holes created in casing to allow fracturing fluid to flow into subterranean formation 104. In any embodiment, perforation holes may be created by a perforating gun and/or other machine to puncture the walls of casing. Perforation holes may be made in any direction in subterranean formation 104 that allows for the extraction of hydrocarbons.

Subterranean formation 104 may be formed of a sedimentary rock layer which is composed of mud, silt, and clay. Subterranean formation 104 may be formed when layers of mud and silt are deposited in the earth, oceans, lakes, and/or rivers. Over time, the weight of the overlying sediment compresses the mud and silt, forming shale. Subterranean formation 104 is often found in layers, with other sedimentary rocks, such as sandstone and limestone. Subterranean formation 104 is typically thin, ranging from a few inches to a few feet in thickness. However, subterranean formation 104 may be thicker, with some formations reaching thicknesses of over 1,000 feet. In any embodiment, subterranean formation 104 may be a source of hydrocarbons 106.

Hydrocarbon deposits, an exemplary one being designated with reference numeral 106 in FIG. 1A, are resources (e.g., oil and/or natural gas) formed from organic matter within subterranean formation 104. Hydrocarbon deposits 106 may be dispersed within subterranean formation 104, as shown in FIG. 1A and not easily accessible. Consequently, extracting hydrocarbons from subterranean formation 104 may be achieved via hydraulic fracturing, e.g., through fracture(s) 108 in FIG. 1A created in subterranean formation 104.

A fracture 108 is a planar crack in subterranean formation 104 which is created by pumping fracturing fluid into subterranean formation 104 at high pressure. A fracture 108 begins at perforation hole(s) (through casing of borehole 102). Fracture(s) 108 may be several hundred feet long and several inches wide. They can also be complex, with multiple branches and extensions. Fractures 108 may be formed by a frac system at the surface.

FIG. 1B is a diagram illustrating an example of a frac system 110 for treatment operations, according to aspects of the present disclosure. Frac system 110 may comprise a fluid management system 110 in fluid communication with a blender system 120. Blender system 120 may in turn be in fluid communication with one or more pumping systems 130 through a fluid manifold system 140. Fluid manifold system 140 may provide fluid communication between pumping systems 130 and a wellbore 150. In use, fluid management system 112 may receive water or another fluid from a fluid source 114 (e.g., a ground water source, a pond, one or more frac tanks), mix one or more fluid additives into the received water or fluid to produce a treatment fluid with a desired fluid characteristic, and provide the produced treatment fluid to blender system 120. Blender system 120 may receive the produced treatment fluid from fluid management system 110 and mix the produced treatment fluid with a proppant, such as sand, or another granular material 125 to produce a final treatment fluid that is directed to fluid manifold 140. Pumping systems 130 may then pressurize the final treatment fluid to generate pressurized final treatment fluid that is directed into wellbore 150, where the pressurized final treatment fluid generates fractures within a formation in fluid communication with wellbore 150.

An example one of pumping systems 130 may comprise a first mover 130a, a pump 130b, and a drive train 130c. As used herein, a mover may comprise any device that converts energy into mechanical energy to drive a pump. Example movers comprise, but are not limited to, electric pump motors, hydrocarbon-driven or steam engines, turbines, etc. Drive train 130c may be removably coupled to first mover 130a and pumps 130b through one or more drive shafts (not shown), and may comprise a transmission 130d with one or more gears that transmits mechanical energy from first mover to the pump 130b. For instance, to the extent pumps 130b comprise reciprocating pumps, the mechanical energy may comprise torque that drives pump 130b.

Drive train 130c may further comprise an electric pump motor 130e. As depicted, the electric pump motor 130e may be coupled to transmission 130d between transmission 130d and pump 130b. In the embodiment shown, electric pump motor 130e may receive mechanical energy from first mover 130a through transmission 130d and provide the received mechanical energy to pump 130b augmented by mechanical energy generated by electric pump motor 130e. It should be appreciated, however, that the orientation of electric pump motor 130e with respect to first mover 130a, transmission 130d, and the pump 130b is not limited to the embodiment shown. In other embodiments, electric pump motor 130e may be positioned between transmission 130 d and first mover 130a, for instance, or between elements of transmission 130d itself. In yet other embodiments, electric pump motor 130e may be incorporated into transmission 130d as part of a hybrid transmission system through which power from both first mover 130a and electric pump motor 130e are provided to pump 130b.

First mover 130a and electric pump motor 130e may receive energy or fuel in one or more forms from sources at the wellsite. The energy or fuel may comprise, for instance, hydrocarbon-based fuel, electrical energy, hydraulic energy, thermal energy, etc. The sources of energy or fuel may comprise, for instance, on-site fuel tanks, mobile fuel tanks delivered to the site, electrical generators, hydraulic pumping systems, etc. First mover 130a and electric pump motor 130e may then convert the fuel or energy into mechanical energy that can be used to drive associated pump 130b.

In the embodiment shown, first mover 130a may comprise an internal combustion engine such as a diesel or dual fuel (e.g., diesel and natural gas) engine and electric pump motor 130e may comprise an electric pump motor. First mover 130a may receive a source of fuel from one or more fuel tanks (not shown) that may be located within the pumping system 130 and refilled as necessary using a mobile fuel truck driven on site. Electric pump motor 130e may be electrically coupled to a source of electricity through a cable 130f. Example sources of electricity comprise, but are not limited to, an on-site electrical generator, a public utility grid, one or more power storage elements, solar cells, wind turbines, other power sources, or one or more combinations of any of the previously listed sources.

As depicted, the source of electricity coupled electric pump motor 130e comprises a generator 160 located at the well site. The generator may comprise, for instance, a gas-turbine generator or an internal combustion engine that produces electricity to be consumed or stored on site. In the embodiment shown, generator 160 may receive and utilize natural gas from the wellbore 150 or from another wellbore in the field (i.e., “wellhead gas”) to produce the electricity. As depicted, frac system 100 may comprise gas conditioning systems 170 that may receive the gas from wellbore 150 or another source and condition the gas for use in the generator 160. Example gas conditioning systems comprise, but are not limited to, gas separators, gas dehydrators, gas filters, etc. In other embodiments, conditioned natural gas may be transported to the well site for use by the generator.

Frac system 110 may further comprise one or more energy storage devices 180 that may receive energy generated by generator 160 or other on-site energy sources and store in one or more forms for later use. For instance, storage devices 180 may store the electrical energy from generator 160 as electrical, chemical, or mechanical energy, or in any other suitable form. Example storage devices 180 comprise, but are not limited to capacitor banks, batteries, flywheels, pressure tanks, etc. In certain embodiments, energy storage devices 180 and generator 160 may be incorporated into a power grid located on site through which at least some of the fluid management system 110, blender system 120, pumping systems 130, and gas conditioning systems 170 may receive power.

In use, first mover 130a and electric pump motor 130e may operate in parallel or in series to drive pump 130b, with the division of power between the movers being flexible depending on the application. For instance, in a multi-stage well stimulation operation, the formation may be fractured (or otherwise stimulated) in one or more “stages,” with each stage corresponding to a different location within the formation. Each “stage” may be accompanied by an “active” period during which pump 130b may be engaged and pressurized fluids are being pumped into wellbore 150 to fracture the formation, and an “inactive” period during which the pumps are not engaged while other ancillary operations are taking place. The transition between the “inactive” and “active” periods may be characterized by a sharp increase in torque requirement.

In an embodiment in which first mover 130a comprises a diesel engine and electric pump motor 130e comprises an electric pump motor, both the diesel engine and electric pump motor may be engaged to provide the necessary power, with the percentage contribution of each depending on the period in which frac system 100 is operating. For instance, during the “inactive” and “active” periods in which the torque requirements are relatively stable, the diesel engine, which operates more efficiently during low or near constant speed operations, may provide a higher percentage (or all) of the torque to the pump than the electric pump motor. In contrast, during transitions between “inactive” and “active” states, the electric pump motor may supplant the diesel engine as the primary source of torque to lighten the load on the diesel engine during these transient operations. In both cases, the electric pump motor reduces the torque required by the diesel engine, which reduces the amount of diesel fuel that must be consumed during the well stimulation operation. It should be noted that power sources could be used during continuous operation or intermittently as needed, including during transmission gear-shift events.

In addition to reducing the amount of diesel fuel needed to perform a well stimulation operation, the use of a first mover and an electric pump motor in a pumping system described herein may provide flexibility with respect to the types of movers that may be used. For instance, natural gas engines, i.e., internal combustion engines that use natural gas as their only source of combustion, are typically not used in oil field environments due to their limited torque capacity. By including two movers within pumping system 130, the torque capacity of the natural gas engine may be augmented to allow the use of a natural gas engine within pumping system 130. For instance, in certain embodiments, first mover 130a may comprise a natural gas engine and electric pump motor 130e may comprise an electric pump motor that operates in series or parallel with the natural gas engine to provide the necessary torque to power pump 130b.

In certain embodiments, pumping systems 130 may be electrically coupled to an information handling system 190 that directs the operation of first movers 130 and electric pump motors 130e of pumping systems 130. Information handling system 190 may further control at least a part of frac system 100. As illustrated, the information handling system 190 may comprise any instrumentality or aggregate of instrumentalities operable to compute, estimate, classify, process, transmit, broadcast, receive, retrieve, originate, switch, store, display, manifest, detect, record, reproduce, handle, or utilize any form of information, intelligence, or data for business, scientific, control, or other purposes. For example, an information handling system 190 may be a personal computer, a network storage device, or any other suitable device and may vary in size, shape, performance, functionality, and price.

Information handling system 190 may comprise a processing unit (e.g., microprocessor, central processing unit, etc.) that may process data from electric pump motor 130 e, discussed below, by executing software or instructions obtained from a local non-transitory computer readable media (e.g., optical disks, magnetic disks). The non-transitory computer readable media may store software or instructions of the methods described herein. Non-transitory computer readable media may comprise any instrumentality or aggregation of instrumentalities that may retain data and/or instructions for a period of time. Non-transitory computer readable media may comprise, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 190 may also comprise input device(s) (e.g., keyboard, mouse, touchpad, etc.) and output device(s) (e.g., monitor, printer, etc.). The input device(s) and output device(s) provide a user interface that enables an operator to interact with any device disposed on or a part of frac system 100 and/or software executed by a processing unit.

For example, information handling system 190 may send one or more control signals to pumping systems 130 to control the speed/torque output of first movers 130a and electric pump motors 130f. The control signals may take whatever form is necessary to communicate with the first movers 130a and electric pump motors 130f. For example, a control signal to electric pump motor 130f may comprise an electrical control signal to a variable frequency drive (VFD), discussed below, coupled to electric pump motor 130f, which may receive the control signal and alter the operation of the electric pump motor based on the control signal.

In certain embodiments, information handling system 190 may also be electrically coupled to other elements of the system, including fluid management system 110, blender system 120, pumping systems 130, generator 160, and gas conditioning systems 170 in order to monitor and/or control the operation of frac system 100. In other embodiments, some or all of the functionality associated with information handling system 190 may be located on the individual elements of the system, e.g., each of pumping systems 130 may have individual controllers that direct the operation of the associated first mover 130a and electric pump motors 130e.

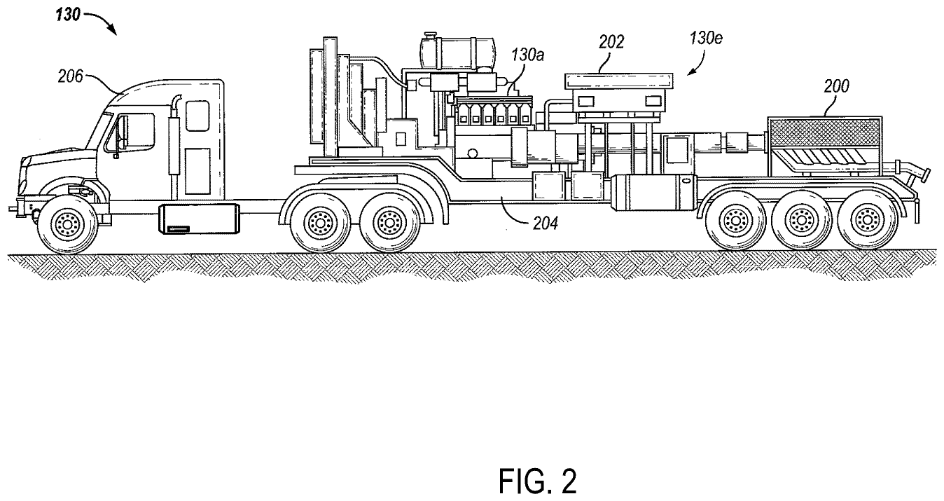

FIG. 2 illustrates an example pumping system 130, according to aspects of the present disclosure. Pumping system 130 may be used, for instance, as one or more of pumping systems 130 described above with reference to FIG. 1. As depicted, pumping system 130 comprises a first mover 130a in the form of a diesel engine coupled to reciprocating positive displacement pump 200 through a transmission system 202 into which an electric pump motor 130f is integrated. First mover 130a, reciprocating positive displacement pump 200, and transmission system 202 may be at least partially mounted on a trailer 204 coupled to a truck 206. Truck 206 may comprise, for instance, a conventional engine that provides locomotion to truck 206 and trailer 204 through a transmission system 202 incorporating an electric pump motor 130f. Transmission system 202 may further comprise an electrical connection, such as a cable, between the transmission of truck 206 and electric pump motor 130f in transmission system 202.

In use, truck 206 and trailer 204 with the pumping equipment mounted thereon may be driven to a well site at which a fracturing or other treatment operation will take place. In certain embodiments, truck 206 and trailer 204 may be one of many similar trucks and trailers that are driven to a well site. Once at the site, reciprocating positive displacement pump 200 may be fluidically coupled to a wellbore 150 (e.g., referring to FIG. 1), such as through a fluid manifold 140 (e.g., referring to FIG. 1), to provide treatment fluid to wellbore 150. Reciprocating positive displacement pump 200 may further be fluidically coupled to a source of treatment fluids to be pumped into the wellbore. When connected, the diesel engine may be started to provide a primary source of torque to reciprocating positive displacement pump 200 through the pump transmission system 202. Electric pump motor 130e in pump transmission system 202 similar may be engaged to provide a supplemental source of torque to reciprocating positive displacement pump 200. As depicted, electric pump motor 130f in pump transmission system 202 may receive energy directly from the transmission of truck 206, such that truck 206 itself operates as an electrical generator for the pumping operation. In addition to energy from truck 206 and electric pump motor 130f in pump transmission system 202, reciprocating positive displacement pump 200 may receive electricity from other energy sources on the site, including a dedicated electrical generator on site or other pumping systems located on the site. During frac operations 100, measurements may be performed to determine downhole properties or wellbore 150 and/or the formation. These measurements may be further processed by additional methods and systems that may utilize information handling system 190.

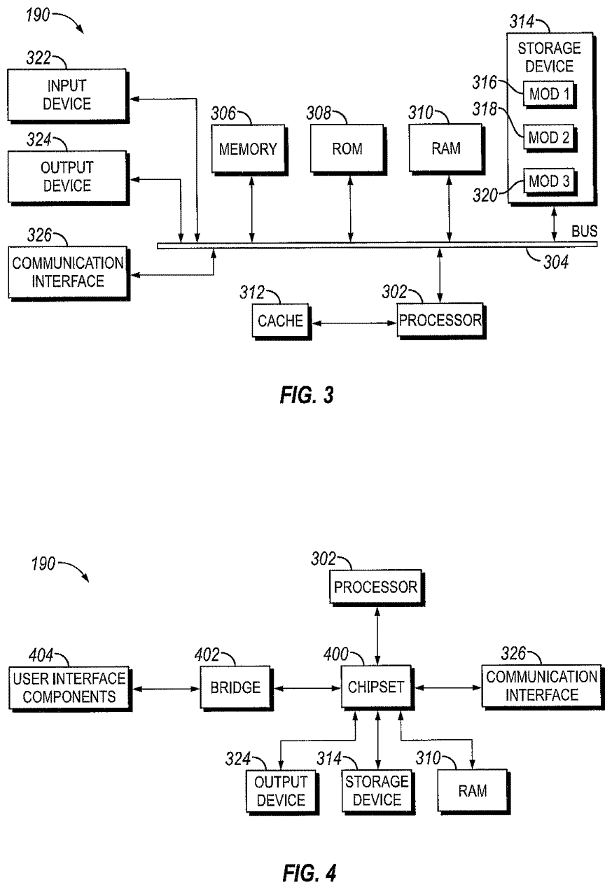

FIG. 3 further illustrates an example information handling system 190 which may be employed to perform various steps, methods, and techniques disclosed herein. Persons of ordinary skill in the art will readily appreciate that other system examples are possible. As illustrated, information handling system 190 comprises a processing unit (CPU or processor) 302 and a system bus 304 that couples various system components including system memory 306 such as read only memory (ROM) 308 and random-access memory (RAM) 310 to processor 302. Processors disclosed herein may all be forms of this processor 302. Information handling system 190 may comprise a cache 312 of high-speed memory connected directly with, in close proximity to, or integrated as part of processor 302. Information handling system 190 copies data from memory 306 and/or storage device 314 to cache 312 for quick access by processor 302. In this way, cache 312 provides a performance boost that avoids processor 302 delays while waiting for data. These and other modules may control or be configured to control processor 302 to perform various operations or actions. Other system memory 306 may be available for use as well. Memory 306 may comprise multiple different types of memory with different performance characteristics. It may be appreciated that the disclosure may operate on information handling system 190 with more than one processor 302 or on a group or cluster of computing devices networked together to provide greater processing capability. Processor 302 may comprise any general-purpose processor and a hardware module or software module, such as first module 316, second module 318, and third module 320 stored in storage device 314, configured to control processor 302 as well as a special-purpose processor where software instructions are incorporated into processor 302. Processor 302 may be a self-contained computing system, containing multiple cores or processors, a bus, memory controller, cache, etc. A multi-core processor may be symmetric or asymmetric. Processor 302 may comprise multiple processors, such as a system having multiple, physically separate processors in different sockets, or a system having multiple processor cores on a single physical chip. Similarly, processor 302 may comprise multiple distributed processors located in multiple separate computing devices but working together such as via a communications network. Multiple processors or processor cores may share resources such as memory 306 or cache 312 or may operate using independent resources. Processor 302 may comprise one or more state machines, an application specific integrated circuit (ASIC), or a programmable gate array (PGA) including a field PGA (FPGA).

Each individual component discussed above may be coupled to system bus 304, which may connect each and every individual component to each other. System bus 304 may be any of several types of bus structures including a memory bus or memory controller, a peripheral bus, and a local bus using any of a variety of bus architectures. A basic input/output (BIOS) stored in ROM 308 or the like, may provide the basic routine that helps to transfer information between elements within information handling system 190, such as during start-up. Information handling system 190 further comprises storage devices 314 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 314 may comprise software modules 316, 318, and 320 for controlling processor 302. Information handling system 190 may comprise other hardware or software modules. Storage device 314 is connected to the system bus 304 by a drive interface. The drives and the associated computer-readable storage devices provide nonvolatile storage of computer-readable instructions, data structures, program modules and other data for information handling system 190. In one aspect, a hardware module that performs a particular function comprises the software component stored in a tangible computer-readable storage device in connection with hardware components, such as processor 302, system bus 304, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 190 is a small, handheld computing device, a desktop computer, or a computer server. When processor 302 executes instructions to perform “operations”, processor 302 may perform the operations directly and/or facilitate, direct, or cooperate with another device or component to perform the operations.

As illustrated, information handling system 190 employs storage device 314, which may be a hard disk or other types of computer-readable storage devices which may store data that are accessible by a computer, such as magnetic cassettes, flash memory cards, digital versatile disks (DVDs), cartridges, random access memories (RAMs) 310, read only memory (ROM) 308, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 190, an input device 322 represents any number of input mechanisms, such as a microphone for speech, a touch-sensitive screen for gesture or graphical input, keyboard, mouse, motion input, speech and so forth. An output device 324 may also be one or more of a number of output mechanisms known to those of skill in the art. In some instances, multimodal systems enable a user to provide multiple types of input to communicate with information handling system 190. Communications interface 326 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 302, that is purpose-built to operate as an equivalent to software executing on a general-purpose processor. For example, the functions of one or more processors presented in FIG. 3 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) 308 for storing software performing the operations described below, and random-access memory (RAM) 310 for storing results. Very large-scale integration (VLSI) hardware embodiments, as well as custom VLSI circuitry in combination with a general-purpose DSP circuit, may also be provided.

FIG. 4 illustrates an example information handling system 190 having a chipset architecture that may be used in executing the described method and generating and displaying a graphical user interface (GUI). Information handling system 190 is an example of computer hardware, software, and firmware that may be used to implement the disclosed technology. Information handling system 190 may comprise a processor 302, representative of any number of physically and/or logically distinct resources capable of executing software, firmware, and hardware configured to perform identified computations. Processor 302 may communicate with a chipset 400 that may control input to and output from processor 302. In this example, chipset 400 outputs information to output device 324, such as a display, and may read and write information to storage device 314, which may comprise, for example, magnetic media, and solid-state media. Chipset 400 may also read data from and write data to RAM 310. A bridge 402 for interfacing with a variety of user interface components 404 may be provided for interfacing with chipset 400. Such user interface components 404 may comprise a keyboard, a microphone, touch detection and processing circuitry, a pointing device, such as a mouse, and so on. In general, inputs to information handling system 190 may come from any of a variety of sources, machine generated and/or human generated.

Chipset 400 may also interface with one or more communication interfaces 326 that may have different physical interfaces. Such communication interfaces may comprise interfaces for wired and wireless local area networks, for broadband wireless networks, as well as personal area networks. Some applications of the methods for generating, displaying, and using the GUI disclosed herein may comprise receiving ordered datasets over the physical interface or be generated by the machine itself by processor 302 analyzing data stored in storage device 314 or RAM 310. Further, information handling system 190 receives inputs from a user via user interface components 404 and executes appropriate functions, such as browsing functions by interpreting these inputs using processor 302.

In examples, information handling system 190 may also comprise tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may comprise RAM, ROM, EEPROM, CD-ROM or other optical disk storage, magnetic disk storage or other magnetic storage devices, or any other device which may be used to carry or store program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be comprised within the scope of the computer-readable storage devices.

Computer-executable instructions comprise, for example, instructions and data which cause a general-purpose computer, special purpose computer, or special purpose processing device to perform a certain function or group of functions. Computer-executable instructions also comprise programming modules that are executed by computers in stand-alone or network environments. Generally, program modules comprise routines, programs, components, data structures, objects, and the functions inherent in the design of special-purpose processors, etc. that perform particular tasks or implement particular abstract data types. Computer-executable instructions, associated data structures, and program modules represent examples of the program code for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

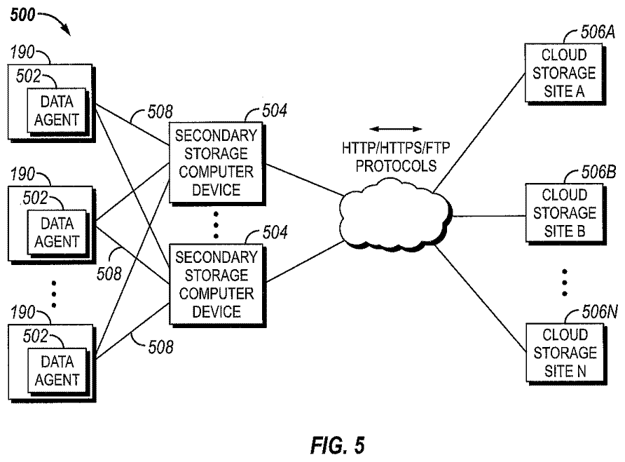

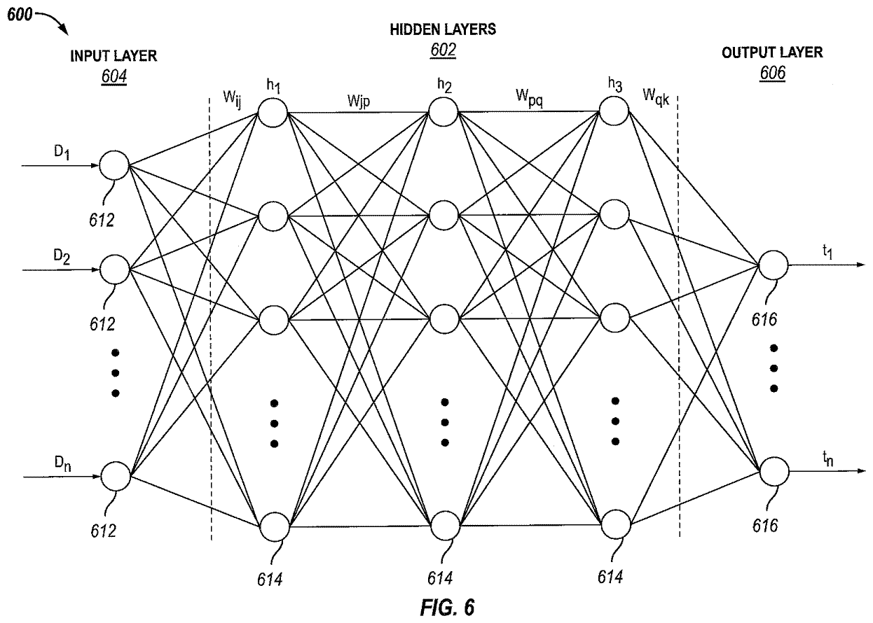

FIG. 5 illustrates an example of an arrangement of resources in a computing network 500 that may employ the processes and techniques described herein, although many others are of course possible. As noted above, an information handling system 190, as part of their function, may utilize data, which comprises files, directories, metadata (e.g., access control list (ACLS) creation/edit dates associated with the data, etc.), and other data objects. The data on the information handling system 190 is typically a primary copy (e.g., a production copy). During a copy, backup, archive or other storage operation, information handling system 190 may send a copy of some data objects (or some components thereof) to a secondary storage computing device 504 by utilizing one or more data agents 502.

A data agent 502 may be a desktop application, website application, or any software-based application that is run on information handling system 190. As illustrated, information handling system 190 may be disposed at any frac site (e.g., referring to FIG. 1), off site location, or repair and manufacturing center. The data agent may communicate with a secondary storage computing device 504 using communication protocol 508 in a wired or wireless system. Communication protocol 508 may function and operate as an input to a website application. In the website application, field data related to pre-and post-operations, generated DTCs, notes, and the like may be uploaded. Additionally, information handling system 190 may utilize communication protocol 508 to access processed measurements, operations with similar DTCs, troubleshooting findings, historical run data, and/or the like. This information is accessed from secondary storage computing device 504 by data agent 502, which is loaded on information handling system 190.

Secondary storage computing device 504 may operate and function to create secondary copies of primary data objects (or some components thereof) in various cloud storage sites 506A-N. Additionally, secondary storage computing device 504 may run determinative algorithms on data uploaded from one or more information handling systems 190, discussed further below. Communications between the secondary storage computing devices 504 and cloud storage sites 506A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 506A-N, the secondary storage computing device 504 may also perform local content indexing and/or local object-level, sub-object-level or block-level deduplication when performing storage operations involving various cloud storage sites 506A-N. Cloud storage sites 506A-N may further record and maintain, EM logs, map DTC codes, store repair and maintenance data, store operational data, and/or provide outputs from determinative algorithms that are located in cloud storage sites 506A-N. In a non-limiting example, this type of network may be utilized as a platform to store, backup, analyze, import, preform extract, transform and load (“ETL”) processes, mathematically process, apply machine learning models, and augment EM measurement data sets.

A machine learning model may be an empirically derived model which may result from a machine learning algorithm identifying one or more underlying relationships within a dataset. In comparison to a physics-based model, such as Maxwell's Equations, which are derived from first principles and define the mathematical relationship of a system, a pure machine learning model may not be derived from first principles. Once a machine learning model is developed, it may be queried in order to predict one or more outcomes for a given set of inputs. The type of input data used to query the model to create the prediction may correlate both in category and type to the dataset from which the model was developed.

The structure of, and the data contained within a dataset provided to a machine learning algorithm may vary depending on the intended function of the resulting machine learning model. The rows of data, or data points, within a dataset may contain one or more independent values. Additionally, datasets may contain corresponding dependent values. The independent values of a dataset may be referred to as “features,” and a collection of features may be referred to as a “feature space.” If dependent values are available in a dataset, they may be referred to as outcomes or “target values.” Although dependent values may be a component of a dataset for certain algorithms, not all algorithms require a dataset with dependent values. Furthermore, both the independent and dependent values of the dataset may comprise either numerical or categorical values.

While it may be true that machine learning model development is more successful with a larger dataset, it may also be the case that the whole dataset isn't used to train the model. A test dataset may be a portion of the original dataset which is not presented to the algorithm for model training purposes. Instead, the test dataset may be used for what may be known as “model validation,” which may be a mathematical evaluation of how successfully a machine learning algorithm has learned and incorporated the underlying relationships within the original dataset into a machine learning model. This may comprise evaluating model performance according to whether the model is over-fit or under-fit. As it may be assumed that all datasets contain some level of error, it may be important to evaluate and optimize the model performance and associated model fit by a model validation. In general, the variability in model fit (e.g.: whether a model is over-fit or under-fit) may be described by the “bias-variance trade-off.” As an example, a model with high bias may be an under-fit model, where the developed model is over-simplified, and has either not fully learned the relationships within the dataset or has over-generalized the underlying relationships. A model with high variance may be an over-fit model which has overlearned about non-generalizable relationships within training dataset which may not be present in the test dataset. In a non-limiting example, these non-generalizable relationships may be driven by factors such as intrinsic error, data heterogeneity, and the presence of outliers within the dataset. The selected ratio of training data to test data may vary based on multiple factors, including, in a non-limiting example, the homogeneity of the dataset, the size of the dataset, the type of algorithm used, and the objective of the model. The ratio of training data to test data may also be determined by the validation method used, wherein some non-limiting examples of validation methods comprise k-fold cross-validation, stratified k-fold cross-validation, bootstrapping, leave-one-out cross-validation, resubstituting, random subsampling, and percentage hold-out.

In addition to the parameters that exist within the dataset, such as the independent and dependent variables, machine learning algorithms may also utilize parameters referred to as “hyperparameters.” Each algorithm may have an intrinsic set of hyperparameters which guide what and how an algorithm learns about the training dataset by providing limitations or operational boundaries to the underlying mathematical workflows on which the algorithm functions. Furthermore, hyperparameters may be classified as either model hyperparameters or algorithm parameters.

Model hyperparameters may guide the level of nuance with which an algorithm learns about a training dataset, and as such model hyperparameters may also impact the performance or accuracy of the model that is ultimately generated. Modifying or tuning the model hyperparameters of an algorithm may result in the generation of substantially different models for a given training dataset. In some cases, the model hyperparameters selected for the algorithm may result in the development of an over-fit or under-fit model. As such, the level to which an algorithm may learn the underlying relationships within a dataset, including the intrinsic error, may be controlled to an extent by tuning the model hyperparameters.

Model hyperparameter selection may be optimized by identifying a set of hyperparameters which minimize a predefined loss function. An example of a loss function for a supervised regression algorithm may comprise the model error, wherein the optimal set of hyperparameters correlates to a model which produces the lowest difference between the predictions developed by the produced model and the dependent values in the dataset. In addition to model hyperparameters, algorithm hyperparameters may also control the learning process of an algorithm, however algorithm hyperparameters may not influence the model performance. Algorithm hyperparameters may be used to control the speed and quality of the machine learning process. As such, algorithm hyperparameters may affect the computational intensity associated with developing a model from a specific dataset.

Machine learning algorithms, which may be capable of capturing the underlying relationships within a dataset, may be broken into different categories. One such category may comprise whether the machine learning algorithm functions using supervised, unsupervised, semi-supervised, or reinforcement learning. The objective of a supervised learning algorithm may be to determine one or more dependent variables based on their relationship to one or more independent variables. Supervised learning algorithms are named as such because the dataset comprises both independent and corresponding dependent values where the dependent value may be thought of as “the answer,” that the model is seeking to predict from the underlying relationships in the dataset. As such, the objective of a model developed from a supervised learning algorithm may be to predict the outcome of one or more scenarios which do not yet have a known outcome. Supervised learning algorithms may be further divided according to their function as classification and regression algorithms. When the dependent variable is a label or a categorical value, the algorithm may be referred to as a classification algorithm. When the dependent variable is a continuous numerical value, the algorithm may be a regression algorithm. In a non-limiting example, algorithms utilized for supervised learning may comprise Neural Networks, K-Nearest Neighbors, Naïve Bayes, Decision Trees, Classification Trees, Regression Trees, Random Forests, Linear Regression, Support Vector Machines (SVM), Gradient Boosting Regression, and Perception Back-Propagation.

The objective of unsupervised machine learning may be to identify similarities and/or differences between the data points within the dataset which may allow the dataset to be divided into groups or clusters without the benefit of knowing which group or cluster the data may belong to. Datasets utilized in unsupervised learning may not comprise a dependent variable as the intended function of this type of algorithm is to identify one or more groupings or clusters within a dataset. In a non-limiting example, algorithms which may be utilized for unsupervised machine learning may comprise K-means clustering, K-means classification, Fuzzy C-Means, Gaussian Mixture, Hidden Markov Model, Neural Networks, and Hierarchical algorithms.

In examples to determine a relationship using machine learning, a neural network (NN) 600, as illustrated in FIG. 6, may be utilized to help identify and/or control the flow rate produced by one or more electric pump motor 130e (e.g., referring to FIG. 1). FIG. 6 illustrates neural network (NN) 600. NN 600 may operate utilizing one or more information handling systems 190 (e.g., referring to FIG. 1) on computing network 500. Although a NN is illustrated, multiple models may be used with input output structures. These models may comprise flexible empirical models such as NN, gaussian processing methods, kriging methods, evolutionary methods such as genetic algorithms, classification methods, clustering methods empirical methods, or physics-based methods such as equations of state, thermodynamic models, geological, geochemistry, or chemistry models, or kinetic models or any combinations therein including recursive combinations of similar or dissimilar models and iterative model combinations. A NN 600 is an artificial neural network with one or more hidden layers 602 between input layer 604 and output layer 606. In examples, NN 600 may be software on a single information handling system 190. In other examples, NN 600 may software running on multiple information handling systems 190 connected wirelessly and/or by a hard-wired connection in a network of multiple information handling systems 190. Herein, NN 600 may be applied in a wide array of implementations.

During operations, input data may be given to neurons 612 in input layer 604. Neurons 612, 614, and 616 are defined as individual or multiple information handling systems 190 connected in a computing network 500. The output from neurons 612 may be transferred to one or more neurons 614 within one or more hidden layers 602. Hidden layers 602 comprises one or more neurons 614 connected in a network that further process information from neurons 612. The number of hidden layers 602 and neurons 612 in hidden layer 602 may be determined by personnel that designs NN 600. Hidden layers 602 is defined as a set of information handling systems 190 assigned to specific processing. Hidden layers 602 spread computation to multiple neurons 612, which may allow for faster computing, processing, training, and learning by NN 600. Output from NN 600 may be computed by neurons 616. An information handling system 190 (e.g., referring to FIG. 1) being utilized in a computing network 500, NN 600, or alone may control frac operations 100. Specifically, using collected data from different forms of subsurface measurements to control frac operations. The data from subsurface measurements are used to make decisions; however, these decisions are made over a long period (at Least a few days to months).

However, current systems do not have a dependable feedback loop in real time enabled by sub-surface data, do not have a structure/solution to acquire high-fidelity sub-surface data at scale, struggle to integrate and process large sets of sub-surface diagnostics data, and/or missing a synchronous digital infrastructure framework to execute frac autonomously. Using the methods and systems describe herein, a closed loop fracturing method and system is disclosed that is based at least in part on decision making workflows which are built on data acquired from sub-surface and surface sensors in real time using proprietary automated processing protocols. For this disclosure, closed loop fracturing is defined as executing frac across an entire well which may or may not have customized stage completion/frac designs as a function of utilizing decision making workflows and pushing the changes in real time without any human intervention to the frac spread for automatically executing the frac job using frac system 110 (e.g., referring to FIGS. 1A & 1B).

Closed loop fracturing may be monitored and/or measured by fiber optic cables. These measurements may be utilized within information handling system 190 (e.g., referring to FIG. 1) being utilized in a computing network 500, NN 600, or alone may control frac operations 100. The technological development of both surface and downhole installed sensor-based systems has provided a significant uplift in how oil and gas operators monitor hydraulic fracture stimulations. These sensor systems may consist of, but are not limited to, pressure and temperature gauges, accelerometers, geophones, hydrophones, and distributed acoustic sensing acquisitions.

With the increase in sensor data recorded and stored for hydraulic fracture stimulations across North American unconventional basins, there is a strong desire to utilize the derived answer products to optimize the completions in both a real time and pseudo real time manner. By developing machine learning model workflows, in a regression and classification sense, recommender systems may be generated to propose changes based on the ML response to the stimulation parameters at the surface. It should be noted that machine learning model workflows may be performed at least in part on information handling system 190 being utilized in a computing network 500, NN 600, or alone. The learnings derived from the machine learning models may enable focused extraction of physics-based fracture modeling insights to provide the recommender system with hybrid optimized stimulation changes to ensure the most consistent frac on a stage-by-stage basis.

The methods and systems discussed below may be utilized on the far-field stimulation effectiveness in how frac system 110 may be propagating at any instance in time, with discrete spatiotemporal events identified by a machine learning model. By following along with our proposed consistency theory, we seek to generate a consistent development of spatial sensor derived events over the course of the stimulation. This may be achieved by tracking the changes in the poroelastic effect generated by frac operations 100 (e.g., referring to FIG. 1) the low frequency component and micro seismic frequency component of distributed acoustic sensing acquired data. Changes in the spatiotemporal or the temporal response at one or more boreholes 102 being monitored may be related to temporal patterns of one or more surface pumping parameters. Tying with closed loop fracturing methodologies, pumping parameters can be varied and observed to maximize the consistency of the ongoing completion.

Low frequency DAS is a spatiotemporal measure of the lengthening and contraction of the deployed cable with frequency content <1 Hz. Low frequency DAS data is the most common data used for monitoring strain events during frac operations 100, and other technologies may also be used. These technologies may use various implementations of e.g. Rayleigh or Brillouin scattering and may in many instances be interferometric in nature. The sensing technologies may e.g. be using homodyne, heterodyne, Michelson, Mach-Zender, Fabry-Perot, phase based, intensity based, coherence based, static(absolute) or dynamic(relative) sensing principles.

Fiber and cable deployment may include permanent cable installations where the cable is clamped outside tubing and cemented in place, temporary deployments using e.g. wireline/slickline/coiled tubing or disposable fiber where a fiber is deployed into a monitoring well for the duration of a fracturing operation.

As an added benefit of DAS acquisitions alongside low frequency strain, fracture failures often generate impulsive data with dominant frequencies of 120-180 Hz known as micro seismic. This micro seismic data is a complimentary measurement to low frequency strain as the fracture failures may be located in 4D space adding dimensionality to a hydraulic fracture completion interpretation as there is intrinsic value in extracted temporal count as well as extracted features.

Low frequency DAS signal processing and machine learning modelling methodology utilized within the hydraulic fracture completion process is incorporated by reference from U.S. Pat. No. 11,970,939B2. The DAS micro seismic signal processing, detection, and location methodology is incorporated by reference from US Patent Application Publication US20240385343A1.

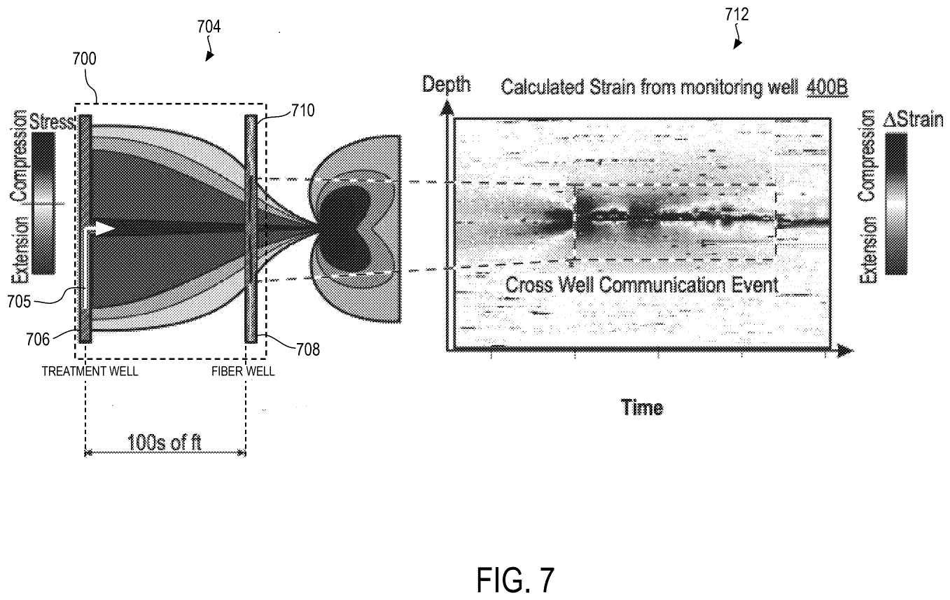

FIG. 7 shows a cutaway 700 from FIG. 1, in which strain data 702 is being collected. As illustrated, strain data 702 measurements may be with respect to time and depth in frac operations 100. More specifically, map view 704 of treatment well 706 and monitoring (fiber) well 708 illustrates a degree of stress observed by a fiber optic cable 710 deployed in monitoring well 708. As indicated by a unidirectional arrow 705 in treatment well 706, fracturing fluid is pumped into treatment well 706. Further, fractures propagate outward from treatment well 706 toward monitoring well 708. When fractures interact with monitoring well 708, such a cross-well communication event is called a “frac hit.”

Map 712 illustrates the original low-frequency data for strain measurements with respect to time and depth that corresponds to map view 794 of treatment well 706 and monitoring well 708. Such strain measurements describe the dynamic stress and strain changes observed by the optic cable deployed in monitoring well 708. In some embodiments, the low-frequency data is DAS data recorded as a 2-dimensional measurement of strain rate with respect to time and depth, as shown in map 712. For example, DAS data in monitoring well 708 (i.e., offset well) fall in the low-frequency bands and linearly correlate with strain and strain rate induced by dynamic fracture propagation. The recorded DAS data shows a spatiotemporal measure of the lengthening and contraction of the deployed optic cable with frequency content less than 1 Hz. Further, the strain measurements of map 712 may be represented in a color scale (e.g., red and blue) to show the degree of extension and compression observed by monitoring well 708.

The low-frequency data as shown in map 712 may be, via 2-D signal processing and data scaling, converted into image data, which may be displayed on information handling system 190. More specifically, strain data 702 may be integrated over a specified time length/window to convert the strain rate to low-frequency strain. The resultant data may be treated as an image, which is optimal for the 2-D signal process and data scaling. Then, a pre-allocated 2-dimensional array of zero values can be built with a full range of measured depth and a predetermined time range. The pre-allocated zero-valued array of traces (i.e., time increments) and samples (i.e., measured depth-sensing points) may be used in machine learning training to preserve aspect ratio. Accordingly, low-frequency strain data can be populated in the pre-allocated 2-dimensional array with respect to a pumping onset when a machine-learning model is applied, as discussed below.

Also, the data may be filtered (e.g., low-pass filtered) to maximize the signal-to-noise ratio. High amplitude traces or samples may skew the statistical nature of the data so their impact can be removed with a filter. A median filter with a pre-defined trace width can be first applied, followed by the removal of the mean on an individual trace basis (e.g., for samples where the absolute value is greater than zero). Also, a singular value decomposition filter can be applied and removes small-scale background noise. Then, the 2-D array can be flattened and scaled such that the mean is 0 and the standard deviation is 1. In some examples where the signal signature is represented in a colored image, the scaled and signal processed 2-D data can be converted into RGB (red, green, and blue) where the color scale is clipped at 3 standard deviations from the mean (for example, time samples*measured depth samples*RGB).

Using the measurements of strain data 702 collected in closed loop fracturing, the process of optimizing hydraulic fracture completions may be performed. Methods and systems discussed below may comprise the use of extracted metrics in both space and time, derived from trained low frequency DAS and DAS micro seismic machine learning model inference, which may be performed at least in part on information handling system 190 being utilized in a computing network 500, NN 600, or alone. Through the acquisition of multiple datasets (hydraulic fracture completions at varying locations across the globe), a historical dataset of extracted attributes can be compiled to use in the training of a machine learning model (regression sense) to optimize in real time.

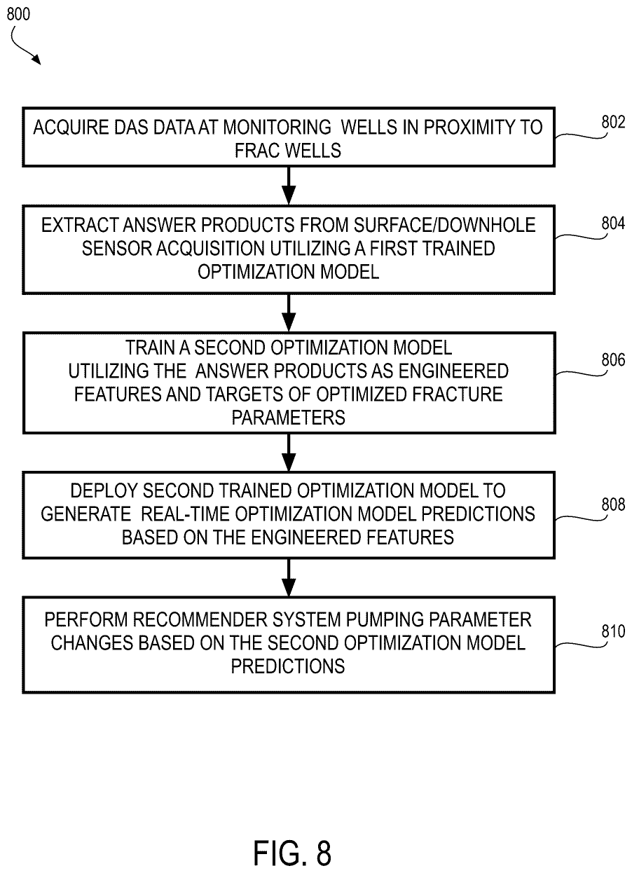

FIG. 8 illustrates workflow 800 for a recommender system implementation of frac spread optimization in accordance with one or more examples. It should be noted that workflow 800 may be performed at least in part on information handling system 190 being utilized in a computing network 500, NN 600, or alone. Workflow 800 may begin with block 802. In block 802 DAS data may be acquired at offset wells from frac wells, as discussed above. In block 804, answer products may be generated from surface/downhole sensor acquisitions. As noted above, a large population of answer product events of engineered features may be recorded for a variety of unconventional wells across global basins, allow for the usage of opimization modeling. The features which may be extracted from the offset well measurements, such as measurements from monitoring well 708, comprise, but are not limited to, low frequency DAS amplitude gradients within the ML detected spatiotemporal positions, the measured depth of detected spatiotemporal positions, the relative positions of detected spatiotemporal positions with respect to one another during a hydraulic pumping stage, the intersection of fractures with respect to an observation well in space/time with respect to volume pumped and height/offset from frac stage, the micro seismic event generation rate, the relative or absolute positions of the micro seismic events (relative to the active pumping stage(s) position(s)), the amplitude ratios of compressional and shear arrivals, as well as absolute amplitude of the event (magnitude). The extracted features may be directly related to frac operation 100, which is controlled at surface in terms of the pumping volumes and proppant concentrations to be injected into the subsurface.

In block 806, one or more optimization models may be trained utilizing the answer products as engineered features and targets of optimized fracture parameters extracted in block 804. By acquiring a statistically relevant number of extracted events, whether low frequency DAS or DAS micro seismic in block 802, and extracting their corresponding engineered features in block 804, machine learning models may be trained. In examples, the optimization models may be maching learning models, physics-based models, data-based empirical models, or a combination thereof.

By determining a set of optimized facture parameters (also referred to as key performance indicators (KPI) with respect to pumping parameters, which includes but is not limited to the idealized sensor response to consistent fracture propagation (asymmetry indicator, etc.) or volume pumped for an estimated fracture propagation or asymmetry at any instance during the completion, an optimization model may be trained, which may be performed at least in part on information handling system 190 being utilized in a computing network 500, NN 600, or alone. The optimization model will use the set of KPI and the engineered features from the low frequency DAS and DAS micro seismic to determine in real time when the optimal set of KPI has been reached, in a regression sense, or in a classification sense (fast, slow, or optimal frac propagation rate bins for example).

In block 808 the trained frac optimization model from block 806 may be deployed, which generates predictions based on answer product features. Specifically, the trained machine learning model may predict in a probabilistic manner in real time when the desired KPI has been achieved. As used herein, “real-time” is intended to mean that the optimization occurs while a fracturing operation is being performed. In one example, optimization may occur once per second, although optimization may occur more or less frequently during a fracturing operation.

In block 810, the recommender system may perform pumping parameter changes based on frac optimization model predictions, which may control frac operations 100 in real time.

The development of closed loop recommender system workflows utilizing DAS derived answer product engineered features follows a set of logic designed to optimize frac operations 100. Logic is designed around physics-based modelling and historical sensor data of fracture propagation and the response of the fracture propagation to an alteration in the frac spread state.

In the case of far field optimization utilizing DAS, the elapsed time or volume which has been pumped (normalized by height and offset between perforation intervals and DAS observation well location) and the machine learning model prediction of a desired target may be measured and/or created. By first order logic of continuing to pump volume at the same rate, or cutting rate, at this predicted time interval, this pumping event and the response at monitoring well 708 with fiber optic cable 710 (e.g., referring to FIG. 7) may be logged. The concept of the ‘piggy bank’ model, or volumetric utilization model, is a preliminary workflow in this same vein where the recommender system may cut volume in the final N number of minutes of a stage based on the supervised learning model prediction of optimal set of KPI. The volume which may be saved from the truncated pumping stage may be set aside and utilized on subsequent stages, wells, or pads, where the supervised learning model does not indicate a prediction of optimal set of KPIs. The nature of this recommender system logic may continue to develop and be refined as more DAS data is collected around these pumping events utilizing a continual update scheme.

As noted above, the recommender system may be performed at least in part on information handling system 190 (e.g., referring to FIG. 1B) being utilized in a computing network 500, NN 600, or alone. Information handling system 190 may run/perform a decision-making protocol to be able to synthesize information from sub-surface diagnostics in real-time. Sub-surface diagnostics may be designed to support automated subsurface monitoring. During operations, sub-surface diagnostics may acquire data from the near well and far field utilizing proprietary sensors. The acquired data is collected through an information handling system 190 positioned on the field that has complete remote capability. The data acquired through information handling system 190, may then be routed to computing network 500 where a NN 600 may utilize algorithms to process the signal responses observed from the raw measurements and output an answer product that may be utilized for making logical decisions. The logical decisions may be used to analyze specific scenarios that may have an impact on the performance of wellbore 102 and/or equipment in frac operation 100. Based at least in part on the scenarios, a recommended alternative option may be produced from computing network 500 and/or NN 600 to modify stage/job designs in frac operation 100. The aforementioned changes may be pushed to equipment in frac operation 100 through automation. Automated systems may then execute these suggested changes as part of the subsequent frac designs without any human intervention. Automated systems may be designed to receive a frac design and pump it to design without any human intervention. Such methods and systems may utilize measurements from different areas of subterranean formation 104 (e.g., referring to FIG. 1).

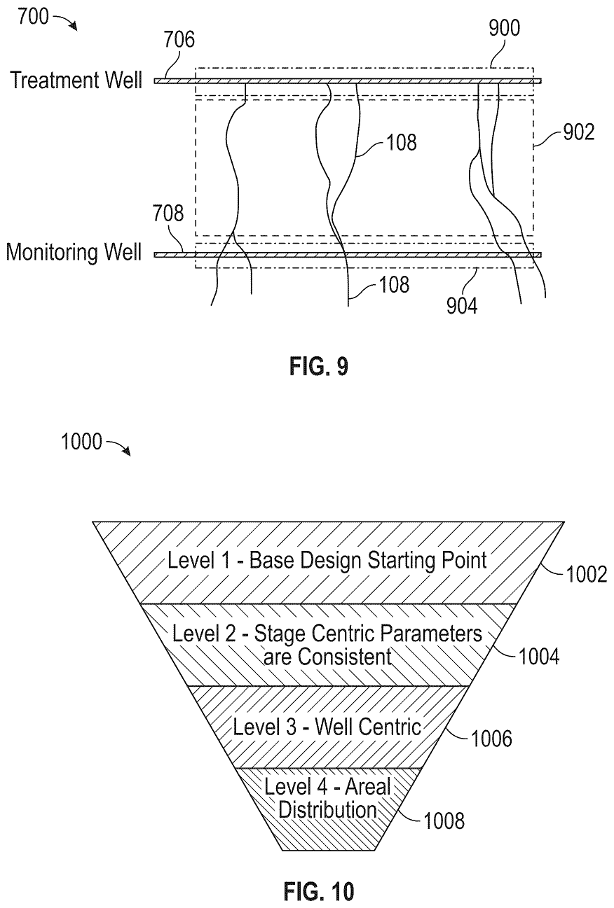

FIG. 9 is a cutaway 700 from FIG. 1A, showing a bird's eye view of a treatment well 706 and monitoring well 708, which may be utilized for automation methods and systems described above. As illustrated, factures 108 are created between and/or around treatment well 706 and/or monitoring well 708. For automated methods and systems, zones may be defined. For example, zone one 900 is defined as an area immediately around and including a near wellbore region of treatment well 706. Zone two 902 is defined as the area between treatment well 707 and monitoring well(s) 708. Zone three 904 is defined as the area immediately around and including monitoring well(s) 708. Within Zone three 904, sensors may be utilized to measure volume to First response Vs horizontal/lateral distance, which may be used to modify frac operations 100. Further sensors within Zone three 904 may use offset measurements such as cumulative strain to characterize fracture morphology/frac corridor width. Further, frac operations 100 may have automated decisions of start/stop a stage as a function of reactivation/event (FDI) location within Zone three 904. Sensors within zone three 904 may utilize offset pressure in combination with strain to categorize VFR responses, and/or further optimization sequence across a pad or DSU (Near well to far field) may be created from measurements within zone three 710. By placing certain types of sensors in Zone three 904, such as fiber optics and/or acoustic sensors, responses can be measured within Zone two 902. These responses may be interpreted as potential fracture propagation patterns.

FIG. 10 illustrates workflow 1000 for a Completion Development Path (CDP) that may provide a cumulative structure to develop new wells/DSUs. It should be noted that workflow 1000 may be performed at least in part by and/or on information handling system 190. Workflow 1000 may begin with block 1002, which may also be referred to as Level 1. In block 1002, base design and starting point may be developed/created. This may be achieved by pulling in data, public or proprietary, and defining the standard completions parameters. Specifically, overall well volumes, and well density may be determined in block 1002. After determining a base design and a starting point in block 1002, workflow 1000 may move to block 1004.

In block 1004, which may be referred to as Level 2, stage centric parameters are identified and formed to be consistent. Block 1004 may be utilized measurements from block 1002, which may be optimized per stage in isolation from other stages. In examples, base parameters such as proppant ramping/concentrations, rates/clusters, fluid design, and cluster designs may be determined. Further, the base parameters may be optimized towards any key performance indicators (KPI), which may have been measured in block 1002. This optimization may be utilized to form a uniformity Index and/or SEI. As block 1002 focuses on an isolated area of borehole 102 (e.g., referring to FIG. 2), the information may be extended across the entire length of borehole 102.

In block 1006, which may be referred to as Level 3, well centric planning may begin. For example, block 1006 may open up the optimizations from block 1004 to the entire borehole 102. Additionally, a volumetric utilization model (VUM or ‘Piggy bank’) may be performed in block 1006. Additionally, in block 1006, stage volumes may be manipulated along borehole 102 while staying constrained by VUM limitations. Both block 1006 and block 1004 measurements may be utilized for entire area frac operations 100 (e.g., referring to FIG. 1).

Block 1008 may be referred to as Level 4, in which areal distribution may be performed. In block 1008, measurements from block 1002 and/or 1004 may be utilized in an optimization ‘area’ which is increased to the pad/DSU. For example, overall well volume/well spacing becomes summarized as pad/DSU volumes. This may allow for VUM to be expanded to all wells on the pad. Additionally, in block 1008 well/stage sequencing may be performed. Further, an additional optimization towards any KPI measured or interpreted in block 1002 and block 1004 may be performed. The optimization to KPI may be in relation to energy, MSM density, cumulative strain, stage corridor width, volume to first arrival (VFR), and/or Morphology.

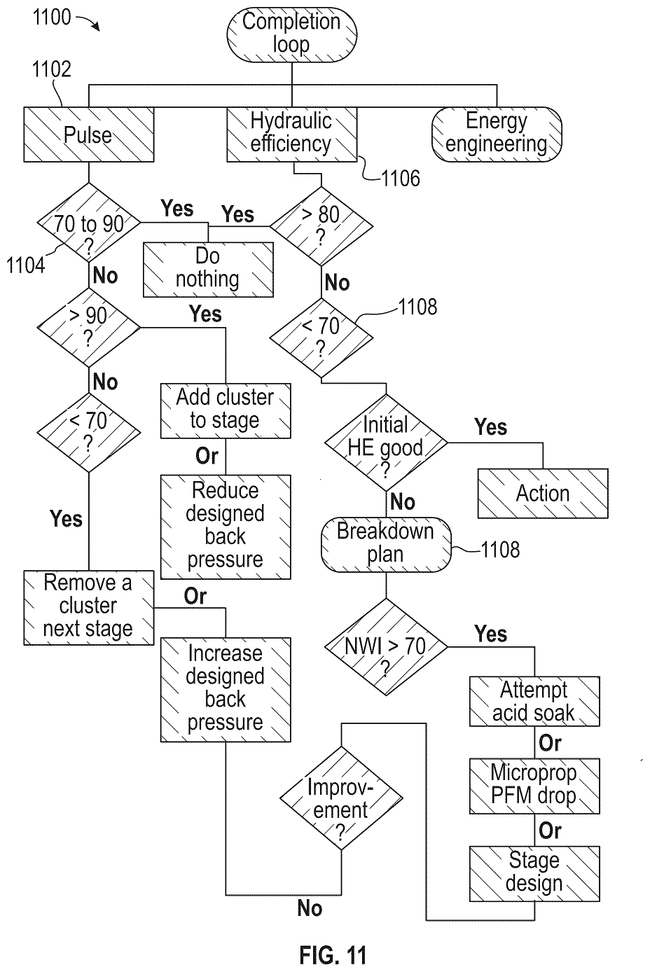

FIG. 11 displays a workflow 1100 for the checks and KPIs required to ‘pass’within block 1004 (e.g., referring to FIG. 10). During workflow 1100, the interpretation of a NWB pressure analysis (Pulse, block 1102) may be utilized to determine if frac operation 100 (e.g., referring to FIG. 1) may be in a ‘safe’ range of operations (between 90 and 70 on the left; decision block 1104). If in a ‘safe’ range, then the next KPI may be checked, which is the time efficiency (Hydraulic Efficiency; block 1106) of fracturing operation 100 on that stage. If it falls below a determined value (in this case 70; decision block 1108), the system may implement another workflow, called the Breakdown plan (block 1110). This Breakdown plan 1110 may comprise of subsequent applications of operational procedures on location, with the planned outcome of increasing consistency of the stage, as covered in block 1004.

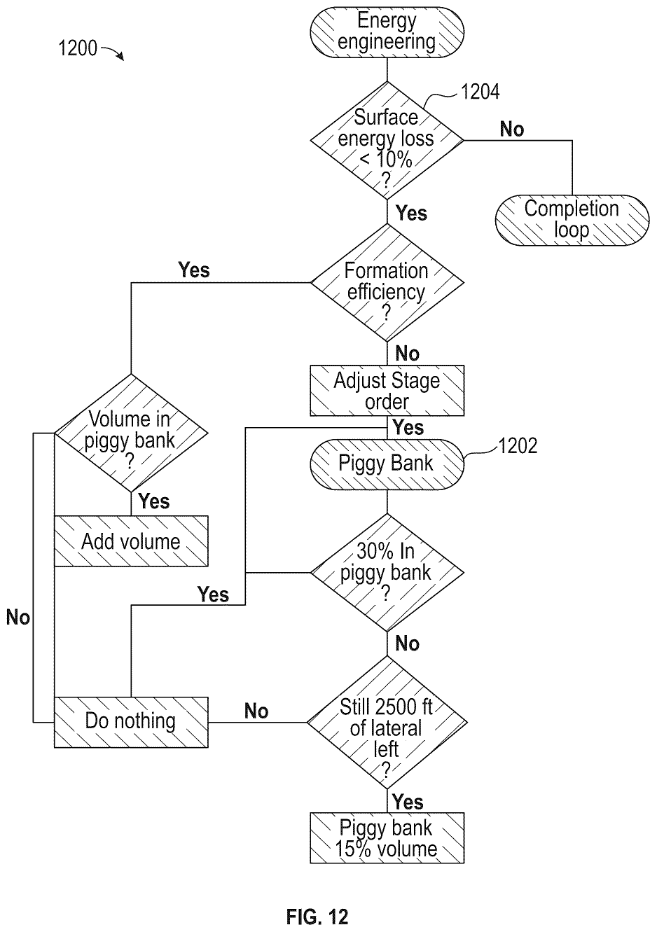

FIG. 12 displays a workflow 1200 for the Breakdown plan. Once block 1004 is complete, workflow 1200 may be utilized as part of block 1006 (e.g., referring to FIG. 10). If applied to a single well, it falls under 1006. Workflow 1200 may be applied to multiple wells at once, in the event of simultaneous operations. In this case, workflow 1200 falls under block 1008. The Piggy Bank 1202 is another name for the VUM as previously described. The optimization here is distribution of energy, as calculated from measured sensors on surface. In this particular workflow, the KPI is energy efficiency. If the system is deemed efficient (energy losses are less than 10%; decision block 1204), then optimization of the overall DSU efficiency can take place, two different actions may be utilized. The VUM (Piggy bank 1202) or adjusting the order in which the stages may be pumped. The determination of which workflow 1100 or 1200 is based on whether or not the current formation is deemed efficient. This is determined beforehand by the engineering/reservoir team. If there isn't enough lateral with the rest of the well, then the actions taken will vary. If the overall energy loss is over a certain value (in this case 10%) then moving into another workflow, such as the Completion Loop, this may be a set of actions taken to decrease energy loss.

The methods and systems disclosed above may be an improvement over existing technology offerings involve the extraction of key fracturing events, in space and time, through real time DAS answer product trained machine learning models. A set of engineered features may be derived from these real time answer product events to be used in a separate supervised learning modelling procedure to solve for an optimal target metric. This machine learning model may be used to determine whether the target metric optimal value has been reached in real time via continuously recording DAS data, which may trigger a recommender system to make changes to the stimulation operations. The changes to the stimulation operations and the corresponding sensor data response will be cataloged and allow for continuous training of the recommender system to achieve the desired sensor response.

Although the present disclosure and its advantages have been described in detail, it should be understood that various changes, substitutions and alterations may be made herein without departing from the spirit and scope of the disclosure as defined by the appended claims.

The preceding description provides various examples of the systems and methods of use disclosed herein which may contain different method steps and alternative combinations of components. It should be understood that although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method, comprising:
acquiring sensor data at monitoring wells in proximity to fracturing wells;
extracting answer products from the acquired sensor data utilizing a first trained optimization model;
training a second optimization model utilizing the answer products as engineered features and targets of optimized fracture parameters;
deploying the second trained optimization model to generate real-time predictions based on the engineered features; and
performing system pumping parameter changes based on the real-time predictions of the second optimization model.

2. The method of claim 1, wherein the sensor data comprises distributed acoustic sensing (DAS) data obtained via a fiber optic cable.

3. The method of claim 2, wherein the first trained optimization model comprises a machine learning model.

4. The method of claim 3, wherein the second trained optimization model comprises a machine learning model.

5. The method of claim 3, wherein the second trained optimization model comprises a physics-based model comprising a set of equations with coefficients matching observed behaviors.

6. The method of claim 3, wherein the second trained optimization model comprises a data-based empirical model.

7. The method of claim 3, wherein the first trained optimization model is an unsupervised machine learning model trained using one of: K-means clustering, K-means classification, Fuzzy C-Means, Gaussian Mixture, Hidden Markov Model, Neural Networks, and Hierarchical algorithms.

8. A fracturing control system, comprising:
an information handling system including a computing network, for:
extracting answer products from sensor data acquired from at least one sensor monitoring wells in proximity to fracturing wells, utilizing a first trained optimization model;
training a second optimization model utilizing the answer products as engineered features and targets of optimized fracture parameters;
deploying the second trained optimization model to generate real-time predictions based on the engineered features; and
performing system pumping parameter changes based on the real-time predictions of the second optimization model.

9. The system of claim 8 wherein the sensor data comprises distributed acoustic sensing (DAS) data obtained via a fiber optic cable.

10. The system of claim 9 wherein the first trained optimization model comprises a machine learning model.

11. The system of claim 10, wherein the second trained optimization model comprises a machine learning model.

12. The system of claim 10, wherein the second trained optimization model comprises a physics-based model comprising a set of equations with coefficients matching observed behaviors.

13. The system of claim 10, wherein the second trained optimization model comprises a data-based empirical model.

14. The system of claim 8, further comprising an electric pump motor operated according to the pump parameter changes.

15. The system of claim 10, wherein the first trained optimization model is an unsupervised machine learning model trained using one of: K-means clustering, K-means classification, Fuzzy C-Means, Gaussian Mixture, Hidden Markov Model, Neural Networks, and Hierarchical algorithms.

16. A computer-readable medium tangibly embodying instructions that, when executed by one or more processors, perform a method for controlling a fracturing operation, the method comprising:
acquiring sensor data at monitoring wells in proximity to fracturing wells;
extracting answer products from the acquired sensor data utilizing a first trained optimization model;
training a second optimization model utilizing the answer products as engineered features and targets of optimized fracture parameters;
deploying the second trained optimization model to generate real-time predictions based on the engineered features; and
performing system pumping parameter changes based on the real-time predictions of the second optimization model.

17. The method of claim 16, wherein the sensor data comprises distributed acoustic sensing (DAS) data obtained via a fiber optic cable.

18. The method of claim 17, wherein the first trained optimization model comprises a machine learning model.

19. The method of claim 18, wherein the second trained optimization model comprises a machine learning model.

20. The method of claim 18, wherein the second trained optimization model comprises a physics-based model comprising a set of equations with coefficients matching observed behaviors.
